(19) United States
(12) Patent Application Publication
(10) Pub. No.: US 2025/0249502 A1
(43) Pub. Date: Aug. 7, 2025

(54) METHOD FOR FORMING SPHERICAL TITANIUM OR TITANIUM ALLOY AND APPLICATION THEREOF

(71) Applicant: Shanghai Tiguan New Material Technology Co., LTD, Shanghai (CN)

(72) Inventor: Wei ZHONG, Shanghai (CN)

(21) Appl. No.: 18/672,089

(22) Filed: May 23, 2024

(30) Foreign Application Priority Data
Feb. 5, 2024 (CN) 202410164645.2

(51) Int. Cl. B22F 1/065; B22F 1/103; B22F 1/142; B22F 1/145; B22F 9/04; B22F 9/08

(52) U.S. Cl. CPC B22F 1/065; B22F 1/103; B22F 1/142; B22F 1/145; B22F 9/04; B22F 9/082; B22F 2009/043; B22F 2301/205; B22F 2304/056; B22F 2304/058; B22F 2304/10

(57) ABSTRACT

The present application relates to the technical field of preparation of titanium and titanium alloy powder and, in particular, to a method for forming a spherical titanium or titanium alloy with a small particle size and an application thereof. The method for forming a spherical titanium or titanium alloy with a small particle size includes the preparation steps of hydrogenation, coarse grinding, fine grinding, granulation, and aftertreatment. The application of the method for forming a spherical titanium or titanium alloy with a small particle size includes: applying the spherical titanium or titanium alloy with a small particle size produced by the method to a 3D printing powder base material or MIM.

### CROSS-REFERENCE TO RELATED APPLICATION

This application is based on and claims the priority and benefits of Chinese patent application serial no. 202410164645.2, filed on Feb. 5, 2024. The entirety of Chinese patent application serial no. 202410164645.2 is hereby incorporated by reference herein and made a part of this specification.

### TECHNICAL FIELD

The present application relates to the technical field of preparation of titanium and titanium alloy powder and, in particular, to a method for forming a spherical titanium or titanium alloy with a small particle size and an application thereof.

### BACKGROUND ART

Titanium is a rare metal element that is very abundant in the earth's crust. Titanium alloys are alloys made of titanium and other metals. The titanium alloys have high strength, strong corrosion resistance, and good heat resistance. Due to their excellent properties, the titanium alloys are widely used in aerospace, medical, sports and other fields.

With the emergence of a 3D printing technology, the titanium and titanium alloys have gradually been used in the civilian field and are often used as base materials for 3D printing, for example, to manufacture prosthetics and dental and orthopedic surgery models in the medical field and to manufacture lightweight parts in the aerospace field, thereby taking full advantage of the flexibility of 3D printing and the high strength and strong corrosion resistance of the titanium alloys and providing more efficient, accurate and personalized manufacturing solutions for various fields. Compared with traditional processing methods, 3D printing can significantly reduce material waste and lower production costs, and it also can create more complex structures, thereby optimizing product performance.

The titanium or titanium alloys are used as base materials for 3D printing. In a case

where titanium or a titanium alloy powder material is used, the titanium or titanium alloy powder material is prepared by means of centrifugal atomization in related technologies. The titanium or titanium alloy is made into a rod to obtain an anode metal rod, and the anode metal rod is then placed on a rotating shaft that rotates at a high speed and melted under the action of a plasma thermal arc. Molten metal droplets diverge into small droplets in a tangential direction under the action of centrifugal force, and after the metal droplets are spheroidized, they are finally solidified into a spherical powder.

However, since the metal droplets may deform during the cooling process, completely spheroidized powder cannot be obtained on the one hand. On the other hand, titanium electrodes are very easy to react with oxygen and become oxidized; and various devices involved in the process will also contaminate the titanium or titanium alloy droplets, seriously affecting the application of laser additives. In addition, the problem of high-speed dynamic sealing will cause a low motor speed and a low fine powder yield, and only 10%- 20% of the powder has a particle size of less than 25 μm. Moreover, since the electrode rod is of a fixed length, continuous atomization cannot be guaranteed and the atomization efficiency is low; and the rod must be made into a specific size, so the cost is high. In order to solve the above problems, a method for forming a spherical titanium or titanium alloy with a small particle size is hereby provided.

### SUMMARY

In order to solve the problem of low yield of submicron-sized fine powder particles in related technologies where titanium or titanium alloy powder materials are prepared by the centrifugal atomization method, the present application provides a method for forming a spherical titanium or titanium alloy with a small particle size and an application thereof.

In a first aspect, the method for forming a spherical titanium or titanium alloy with a small particle size, provided by the present application, adopts the following technical solution:
a method for forming a spherical titanium or titanium alloy with a small particle size including the following steps:
step S1. hydrogenation: hydrogenating metal titanium or a titanium alloy to form a hydride;
step S2. coarse grinding: coarsely grinding the hydride to form polygonal particles with a particle size of less than 10 μm;
step S3. fine grinding: finely grinding the obtained polygonal particles to ensure that the value of D50 is between 300 nm and 500 nm and the value of D100 is between 1200 nm and 1500 nm;
step S4. granulation: adding a binder to the finely ground material and treating the material by a two-fluid atomization method; and
step S5. post-treatment: performing degreasing and dehydrogenating treatments on the atomized material and presintering the material to obtain the product.

By adopting the technical solution described above: a higher proportion of fine powder particles that meet the requirements can be obtained, and less waste and pollutants are produced, causing less impact on the environment; the formation of the hydride and subsequent degreasing and dehydrogenating treatments can reduce the risk of oxidation and contamination to a certain extent.

The possible reasons may be as follows: 1) In the step of fine grinding in step S3, in order to ensure that the particle size distribution of the final powder product reaches an ideal state, a sand mill is used for efficient grinding. By virtue of the high-speed rotation of the sand mill (the rotation speed is maintained within a range of 7000 rpm to 10000 rpm) and the collision of a selected zirconia bead abrasive, the polygonal particles obtained after coarse grinding are further refined to a submicron level.

This process not only significantly improves the fluidity and filling property of the powder, but also plays a crucial role in the molding accuracy and performance of the subsequent 3D printing or MIM (Metal Injection Molding) process. It is worth mentioning that adding organic solvents during the fine grinding process has become a key auxiliary means. The addition of these solvents further improves the dispersion and fluidity of the powder and reduces agglomeration and friction of particles, so that the powder can be ground to a required particle size more easily. In the meanwhile, the organic solvents also effectively control the temperature during the grinding process, avoiding the risk of oxidation or sintering of the powder due to overheating.

The use of the sand mill and the organic solvents not only maintains the high purity of the powder, but also achieves a more efficient grinding effect. In addition, operating parameters of the sand mill, such as grinding time, may also be flexibly adjusted according to actual needs to further optimize the particle size and shape of the powder. The application of this comprehensive method ensures that the final powder product meets the requirements of various complex processes while maintaining a high quality.

2) The two-fluid atomization method is a preparation method that crushes the titanium melt into tiny droplets by virtue of high-speed, high-pressure airflow generated by a nozzle and then quickly solidifies the tiny droplets into powder at a low temperature. In a traditional two-fluid atomization preparation process, for submicron-sized particles, it often faces challenges in fluidity and stability. Adding a binder is considered to be an effective means to increase preparation efficiency and improve the quality and particle size distribution of the powder.

The two-fluid atomization method is a key step in preparing a high-quality spherical titanium alloy powder. In this process, the introduction of the binder in combination with the atomization technology brings outstanding advantages to the preparation of the powder.

The binder plays a vital role in the mixture. It can effectively bind the titanium or titanium alloy particles together to form uniform spherical particles. This bonding effect not only improves the sphericity of the powder, but also makes the particle size of the powder more uniform. Moreover, the selection of the binder is also crucial for controlling the purity and particle size of the powder. A high-quality binder can ensure the high purity and small particle size of the final powder product.

The two-fluid atomization method provides a strong support for the binder. The binder is atomized into tiny droplets at a high temperature. A liquid flow and an air flow collide with each other and break up into spheres. These droplets can be more evenly distributed in the mixture when reacting with the titanium alloy, which not only increases the contact area between the binder and the titanium alloy particles and improves the bonding effect, but also helps to control the particle size distribution of the powder.

Preferably, an organic solvent having a mass 0.6-10 times that of the hydride needs to be added in step S2, and an organic solvent having a mass 0-10 times that of the polygonal particle slurry also needs to be added in step S3.

In the above technical solution, the organic solvents added during the coarse grinding and fine grinding processes take lubricating and dispersing effects, helping to obtain more uniform powder particles. The use of the organic solvents can increase grinding efficiency and reduce agglomeration of particles, thereby obtaining a powder product of higher quality.

Preferably, the organic solvent is a non-polar solvent;
the non-polar solvent is any one of n-heptane or xylene or a mixture thereof.

In the above technical solution, both of n-heptane and xylene can achieve the lubricating and dispersing effects, which is beneficial to increasing grinding efficiency and improving powder quality.

Preferably, in step S2, a ball mill is used for coarse grinding, silicon carbide or zirconia is used as an abrasive, the grinding time is within a range of 1 h to 12 h, a weight ratio of the abrasive to the hydride on a dry basis is (5-50):1, and the rotation speed is within a range of 100 rpm to 300 rpm.

In the above technical solution, since the ball mill is used as a coarse grinding device and silicon carbide or zirconia is used as the abrasive, within the grinding time of 1-12 h, the hydride particles can be effectively broken into polygonal particles with a particle size of less than 10 μm. Such particle size control provides a good foundation for the subsequent step of fine grinding and ensures an increase in the yield of fine powder particles.

Preferably, in step S3, a sand mill is used for fine grinding, zirconia is used as an abrasive, a grinding time is within a range of 0.25 h to 6 h, a weight ratio of the abrasive to the hydride on a dry basis is (1-50):1, and a rotation speed is within a range of 7000 rpm to 10000 rpm.

In the above technical solution, the sand mill accelerates the material to a high speed so that the material is fiercely collided and rubbed with the abrasive, thus achieving efficient crushing. This crushing method can further refine the polygonal particles to the required size in a short period of time. The particle size distribution of the obtained powder is usually within a narrow range, which is beneficial to improving the yield of fine powder particles; moreover, a spherical powder with uniform particle size distribution and regular shape can also be obtained.

Preferably, the binder in step S4 is composed of a modified polyimide and 1-2 wt % of a surfactant;
raw materials for preparing the modified polyimide include the following components: 10-20 parts of polysiloxane, 5-10 parts of benzimidazole and 80-100 parts of polyimide.

In the above technical solution, by selecting a binder of appropriate composition and proportion, the property indicators of the powder particles, such as fluidity, compressibility and sintering properties, can be optimized. This will help to improve the formability and sintering property of the powder particles to form spherical powder. Moreover, pollution can be reduced to a certain extent.

Preferably, the presinstering temperature in step S5 is within a range of 500° C. to 600° C.

In the above technical solution, by controlling the presintering temperature within the range of 500° C. to 600° C., organic residues in the powder can be effectively removed and excessive sintering of the powder is also avoided; and by accurately controlling the presintering temperature and time, a powder product with good sintering activity can be obtained.

In a second aspect, the application of the method for forming a spherical titanium or titanium alloy with a small particle size, provided by the present application, adopts the following technical solution:
an application of the method for forming a spherical titanium or titanium alloy with a small particle size, including applying the spherical titanium or titanium alloy with a small particle size produced by the method for forming a spherical titanium or titanium alloy with a small particle size to a 3D printing powder base material or MIM.

In the above technical solution, the efficient preparation and accurate control process of powder particles are achieved, with clear and coherent steps, thereby ensuring efficient conversion from raw materials to products. The flexible adjustability of process parameters in each step provides the possibility for customized production of products. The overall process complies with environmentally friendly production requirements, which is conducive to sustainable development. The above technical solution not only improves production efficiency and reduces production costs, but also ensures product quality and the yield of fine powder particles, thereby providing a strong support for the application of the titanium or titanium alloy powder in 3D printing, MIM and other fields.

To sum up, the present application includes at least one of the following beneficial technical effects:
1. The present application achieves efficient refinement of the titanium or titanium alloy powder through three consecutive steps of hydrogenation, coarse grinding and fine grinding. The step of hydrogenation provides a suitable material state for subsequent grinding. Coarse grinding quickly breaks the hydride to small particle sizes. Fine grinding further refines the particles to the submicron level, meeting the strict requirements for the particle size of the powder in high-precision applications.
2. In the present application, a binder of a specific composition (composed of a modified polyimide and 1 wt % of surfactant) is added to the finely ground powder and atomization treatment is then performed so that the powder particles become a spherical shape. This spherical shape significantly improves the fluidity, filling property and tap density of the powder, providing an ideal molding basis for subsequent 3D printing or MIM processes. In the meanwhile, the addition of the binder also enhances the bonding force between powder particles and improves the strength and stability of a molded body.
3. According to the present application, by post-treatment steps such as degreasing, dehydrogenating and presintering, organic components and hydride residues in the powder are removed, thereby ensuring the purity and stability of the powder. These post-treatment steps not only consolidate the structure of the powder particles, but also guarantee the properties of the final product. In particular, the presintering process further consolidates the bonding of powder particles at a temperature of 500-600° C., laying a foundation for the mechanical properties and chemical stability of the final product.

### DETAILED DESCRIPTION

The present application will be further described in detail below with reference to the examples. Raw materials used in the present application are all commercially available common materials, unless otherwise specified below.

### Preparation Examples 1-4

Prepared was a modified polyimide, and the components of the modified polyimide and their corresponding weights (kg) were listed as follows:

TABLE
Components of the modified polyimide and their
weight (kg) in Preparation Examples 1-4

| Component Preparation | | | | |
|---|---|---|---|---|
| Example | 1 | 2 | 3 | 4 |
| Polyimide | 80 | 100 | 100 | 100 |
| Polysiloxane | 10 | 10 | 20 | 20 |
| Benzimidazole | 5 | 5 | 5 | 10 |

### Performance Testing

The sample powders prepared in Examples and Comparative Examples were selected as test objects and tested for their particle sizes and particle size distribution. The test methods were as follows:
According to GB/T29022-2012 Particle size Analysis—Dynamic light scattering (DLS), a nano laser particle size analyzer was used for testing. Each of the samples to be tested was measured repeatedly for five times.

The test results were averaged and recorded in the table below.

### EXAMPLES

### Example 1

### Example 1

Provided was a method for forming a spherical titanium or titanium alloy with a small particle size and its specific preparation process was as follows:
step S1. hydrogenation: metal titanium or a titanium alloy was heated to 900° C. in a reduction furnace and hydrogen was introduced for 45 min, so that hydrogen fully reacted with the metal titanium or the titanium alloy to generate a hydride;
step S2. coarse grinding: a ball mill was started and preheated to an appropriate working temperature; the hydride obtained in step S1, silicon carbide and n-heptane were well mixed according to a feeding ratio of 1:40:5 and then ground in the ball mill at 200 rpm for 8 h; after the grinding was completed, polygonal particle slurry was then taken out for subsequent treatment or use;
step S3. fine grinding: a sand mill was started and preheated to an appropriate working temperature; the polygonal particle slurry obtained in step S2, zirconium oxide and n-heptane were well mixed according to a feeding ratio of 1:20:10 and then ground in the sand mill at 8000 rpm for 5 h;
step S4. granulation: the finely ground material was dried to remove moisture and organic solvents; a binder was added to and well mixed with the dried material, wherein the binder was composed of a modified polyimide and 1 wt % of a surfactant and the modified polyimide was prepared according to Preparation Example 1; the mixed material was then subjected to high-temperature atomization treatment so that the material was dispersed into tiny particles; the atomized particles were then collected for subsequent treatment or use; and
step S5. post-treatment: the material atomized in step S4 was placed in a degreasing container and a dehydrogenating container in sequence to remove the residual organic solvent, hydrogen and other impurities from the material, and the dehydrogenated material was then presintered in a presintering furnace at 550°° C. for 1.5 h and then cooled to room temperature, thus obtaining the spherical titanium or titanium alloy with a small particle size.

### Example 2

A method for forming a spherical titanium or titanium alloy with a small particle size differs from Example 1 in that high-purity silicon carbide was used as an abrasive in step S3 in this example.

### Example 3

A method for forming a spherical titanium or titanium alloy with a small particle size differs from Example 1 in that the feeding ratio of the hydride to zirconium oxide to n-heptane was 1:5:0.6 in step S3 in this example.

### Example 4

A method for forming a spherical titanium or titanium alloy with a small particle size differs from Example 1 in that the feeding ratio of the hydride to zirconium oxide to n-heptane was 1:50:0.6 in step S3 in this example.

### Example 5

A method for forming a spherical titanium or titanium alloy with a small particle size differs from Example 1 in that the feeding ratio of the hydride to zirconium oxide to n-heptane was 1:50:10 in step S3 in this example.

### Example 6

A method for forming a spherical titanium or titanium alloy with a small particle size differs from Example 1 in that in step S3, the rotation speed of the sand mill was 12000 rpm and the grinding time was 2 h in this example.

### Example 7

A method for forming a spherical titanium or titanium alloy with a small particle size differs from Example 1 in that in step S3, the rotation speed of the sand mill was 5000 rpm and the grinding time was 10 h in this example.

### Example 8

A method for forming a spherical titanium or titanium alloy with a small particle size differs from Example 1 in that in this example, the feeding ratio of the hydride to zirconium oxide to n-heptane was 1:40:15 in step S2, and the feeding ratio of the polygonal particle slurry to zirconium oxide was 1:20 in step S3, that is, n-heptane was added all at once in step S2, and no more n-heptane was supplemented in step S3.

### Example 9

A method for forming a spherical titanium or titanium alloy with a small particle size differs from Example 1 in that in this example, the feeding ratio of the hydride to zirconium oxide to n-heptane was 1:40:10 in step S2, the feeding ratio of the polygonal particle slurry to zirconium oxide was 1:20 in step S3, and after the fine grinding was completed, n-heptane in an amount 5 times that of the polygonal particle slurry was supplemented into the ground slurry.

### Comparative Example 1

A method for forming a spherical titanium or titanium alloy with a small particle size differs from Example 1 in that the metal titanium or titanium alloy was directly used without being hydrogenated in this comparative example.

### Comparative Example 2

A method for forming a spherical titanium or titanium alloy with a small particle size differs from Example 1 in that the step of coarse grinding was omitted in this comparative example.

### Comparative Example 3

A method for forming a spherical titanium or titanium alloy with a small particle size differs from Example 1 in that the step of fine grinding was omitted in this comparative example.

### Comparative Example 4

A method for forming a spherical titanium or titanium alloy with a small particle size differs from Example 1 in that ethanol, instead of n-heptane, was used in step S2 and step S3 in this comparative example.

The powders prepared in Examples 1-9 and Comparative Examples 1-4 were sampled and then tested for their particle size distribution according to the above measurement standards. The test results were averaged and recorded in the table below.

TABLE
Test results of particle size distribution of samples
from Examples 1-9 and Comparative Examples 1-4

Test item

| Group | D50 (mm) | D100 (mm) |
|---|---|---|
| Example 1 | 332 | 1486 |
| Example 2 | 265 | 1154 |
| Example 3 | 294 | 1225 |
| Example 4 | 327 | 1448 |
| Example 5 | 349 | 1490 |
| Example 6 | 331 | 1451 |
| Example 7 | 335 | 1477 |
| Example 8 | 268 | 1235 |
| Example 9 | 251 | 1169 |
| Comparative Example 1 | 3463 | 1.52*10⁴ |
| Comparative Example 2 | 581 | 2932 |
| Comparative Example 3 | 3.2*10⁴ | 1.25*10⁵ |
| Comparative Example 4 | 683 | 1864 |

It can be seen from the above table that: the titanium or titanium alloy powder particles prepared in Examples 1-9 have D50 of 251-349 mm and D100 of 1154-1490 mm, which means that the yield of the spherical titanium or titanium alloy powder particles produced by this solution is still high at the submicron level;

Example 2 shows the best performance, high-purity silicon carbide was used as the abrasive for fine grinding, and the high-purity silicon carbide has excellent wear resistance and chemical stability and can be used for a long time under harsh conditions such as high speed, high temperature and high pressure, with less loss; moreover, the high-purity silicon carbide also has good thermal conductivity and can quickly dissipate the heat generated during the grinding process, thereby avoiding damage and deformation caused by heat and ensuring the accuracy and quality of grinding; however, compared with zirconia, the high-purity silicon carbide is more expensive, which is unfavourable for cost control;
in addition, the various process conditions in Examples 3-7 are important factors affecting the particle size and particle size distribution of the final products; an appropriate feeding ratio can ensure that various raw materials are well mixed, thereby improving grinding efficiency and helping to obtain more uniform and finer particles; the rotation speed is a key parameter that affects the grinding effect and an appropriate rotation speed can provide appropriate grinding force, so that the material is fully rubbed and collided in the sand mill, thereby promoting the refinement of the material; too high or too low rotation speed may lead to poor grinding effect, uneven particle size distribution, and low fine powder yield; and
as a grinding medium, zirconia can enhance the grinding effect and increase the grinding efficiency and refinement degree of the material, and moreover the zirconia has high chemical stability and will not has chemical reactions harmful to the material.

Ethanol can play a role in wetting and dispersing the material, allowing the material to be better mixed and dispersed in the grinding medium. Ethanol can also effectively reduce the viscosity of the material and help to increase the grinding efficiency.

Sufficient grinding time can ensure that the material has enough time to be fully ground and mixed, thereby obtaining finer and more uniform particles; if the grinding time is too short, it may lead to insufficient grinding and wide particle size distribution, thereby affecting product quality; if the grinding time is too long, it may lead to over-grinding and higher energy consumption, thereby increasing costs, and it may also cause accelerated wear, thereby shortening the service life of equipment.

In Examples 8-9, the organic solvent n-heptane was added in different ways. In Example 8, n-heptane was added all at once during the coarse grinding process. In Example 9, n-heptane was added step by step: some n-heptane was first added in the coarse grinding and then additional n-heptane was supplemented after the fine grinding was completed.

From the perspective of particle size distribution: in Example 8, the value of D50 was 268 mm and the value of D100 was 1235 mm. This may result from that a large amount of n-heptane is added at one time so that the coarse grinding and fine grinding processes are more complete, and for this reason, no additional n-heptane is required, which helps to reduce volatilization.

In Example 9, the value of D50 was 251 mm and the value of D100 was 1169 mm. Since n-heptane was added step by step, the time of coarse grinding and fine grinding processes can be more accurately controlled, thereby greatly improving the fine grinding efficiency greatly.

For Comparative Examples 1-3, the values of D50 of the samples are between 581 mm and 3.2*10⁴ mm and the values of D100 of the samples are between 2932 mm and 1.25*10⁵ mm. This means that the particle size distribution is uneven and the yield of powder with a small particle size is low. The possible reasons are analyzed as follows:
1) The hydrogenation process can improve the surface properties of the titanium or titanium alloys and improve their oxidation resistance and corrosion resistance. Without this step, it may be difficult to effectively control the particle size distribution in subsequent grinding and atomization treatments, the properties of the products may be affected, and the titanium or titanium alloys may not be sufficiently refined.
2) Coarse grinding is performed to break the hydride into smaller particle sizes. Without this step, the resulting particles may be relatively large and unable to meet the expected particle size distribution requirements. By coarse grinding, the resulting particles can be more uniform in size and the final particle size distribution can be better controlled, and omitting of this step will result in a lower or even no yield of fine powder particles. So coarse grinding is essential to ensure that the final particle size distribution meets the requirements.
3) The step of fine grinding is performed to grind the material more finely by means of a high-speed centrifugal mill to achieve smaller and more uniform particle sizes. Without this step, it may cause the particle size distribution to become larger and wider, and especially it may cause the increase in the values of D50 and D100. During the fine grinding process, the material is ground at a high speed, which helps the material form a more regular spherical or nearly spherical shape. Without this step, it may cause the material to become irregular in shape and unable to form a spherical shape, and may reduce the yield of fine powder.

In Comparative Example 4, after the polar solvent ethanol was used to replace n-heptane, the particle size distribution was uneven with the value of D50 being 683 mm and the value of D100 being 1864 mm, and the yield of submicron-sized particles was reduced. The possible reason is analyzed as follows: changes in the crushing and formation mechanism of particles during the grinding process are caused by the difference in dissolution properties between ethanol and n-heptane, thus affecting the final particle size distribution.

In addition, ethanol is more volatile than n-heptane and may evaporate faster, which reduces its effect in the grinding process and affects the grinding environment, thus affecting the particle size distribution.

### Examples 10-12

A method for forming a spherical titanium or titanium alloy with a small particle size differs from Example 1 in the use of the modified polyimide in the binder in step S4, and the specific corresponding relationship is shown in the table below.

TABLE
Comparison table of usage of the modified
polyimide in Examples 10-12

| Group | Modified polyimide |
|---|---|
| Example 10 | Prepared according to Preparation example 2 |
| Example 11 | Prepared according to Preparation example 3 |
| Example 12 | Prepared according to Preparation example 4 |

### Comparative Example 5

A method for forming a spherical titanium or titanium alloy with a small particle size differs from Example 1 in that no binder was used in step S4 in this comparative example.

### Comparative Example 6

A method for forming a spherical titanium or titanium alloy with a small particle size differs from Example 1 in that
the binder used in step S4 did not contain any surfactant in this comparative example.

The powders prepared in Examples 10-12 and Comparative Examples 5-6 were sampled and then tested for their particle size distribution according to the above measurement standards. The test results were averaged and recorded in the table below.

TABLE
Test results of particle size distribution of samples
from Examples 10-12 and Comparative Examples 5-6

Test item

| Group | D50 (mm) | D100 (mm) |
|---|---|---|
| Example 1 | 332 | 1486 |
| Example 10 | 310 | 1337 |
| Example 11 | 298 | 1265 |
| Example 12 | 303 | 1195 |
| Comparative Example 5 | 284 | 1552 |
| Comparative Example 6 | 300 | 1501 |

It can be seen from the above table that: the titanium or titanium alloy powder particles prepared in Examples 10-12 have D50 of 298-310 mm and D100 of 1195-1337 mm, which means that the yields of submicron-level fine powder particles are all relatively high; and

From the perspective of the component proportions of the binder, as the additions of polysiloxane and benzimidazole increase, the yield of the submicron-level titanium or titanium alloy powder particles produced also increases slightly.

Polysiloxane participates in the modification process of polyimide and changes the properties of the binder. The modified binder has a stronger interaction with the powder particles and can more effectively prevent powder loss during the treatment process, thereby increasing the yield. In addition, during the high-temperature atomization treatment process, the binder closely binds to the powder particles to form stable particles. As the additions of polysiloxane and benzimidazole increase, this binding effect can be further enhanced.

As for Comparative Examples 5 and 6, the values of D50 of the samples are between 284 mm and 300 mm, and the values of D100 of the samples are between 1501 mm and 1552 mm.

The binder can play a key role in the granulation process, and it can make the material better dispersed into tiny particles during atomization; if no binder is added, the adhesion and aggregation of the material may increase, and the particle size distribution will be more concentrated in a smaller range. In addition, due to the lack of dispersion of the binder, the particle size distribution of the material may become wider. This means a possible increase in the value of D100 may increase, thereby affecting the yield of fine powder and reducing product quality.

### Example 13

A method for forming a spherical titanium or titanium alloy with a small particle size differs from Example 1 in that the presintering was performed at 800° C. for 1 h in step S5 in this example.

### Example 14

A method for forming a spherical titanium or titanium alloy with a small particle size differs from Example 1 in that the presintering was performed at 400° C. for 2 h in step S5 in this example.

### Comparative Example 7

A method for forming a spherical titanium or titanium alloy with a small particle size differs from Example 1 in that the steps of degreasing and dehydrogenating treatments were omitted in step S5 in this comparative example.

### Comparative Example 8

A method for forming a spherical titanium or titanium alloy with a small particle size differs from Example 1 in that,
the finely ground material was treated by means of vacuum distillation in step S4 in this comparative example.

### Comparative Example 9

A method for forming a spherical titanium or titanium alloy with a small particle size differs from Example 1 in that,
the finely ground material was treated by means of chemical vapor deposition in step S4 in this comparative example.

### Comparative Example 10

A method for forming a spherical titanium or titanium alloy with a small particle size differs from Example 1 in that,
the finely ground material was treated by a three-fluid atomization method in step S4 in this comparative example.

### Comparative Example 11

A method for forming a spherical titanium or titanium alloy with a small particle size differs from Example 1 in that,
the finely ground material was treated by means of four-fluid atomization in step S4 in this comparative example.

The powders prepared in Examples 13-14 and Comparative Examples 7-11 were sampled and then tested for their particle size distribution according to the above measurement standards. The test results were averaged and recorded in the table below.

TABLE
Test results of particle size distribution of samples
from Examples 13-14 and Comparative Examples 7-11

Test item

| Group | D50 (mm) | D100 (mm) |
|---|---|---|
| Example 1 | 332 | 1486 |
| Example 13 | 366 | 1592 |
| Example 14 | 351 | 1547 |
| Comparative Example 7 | 1014 | 1.21*10⁴ |
| Comparative Example 8 | 340 | 1746 |
| Comparative Example 9 | 351 | 1328 |
| Comparative Example 10 | 336 | 1443 |
| Comparative Example 11 | 328 | 1460 |

It can be seen from the above table that: the titanium or titanium alloy powder particles prepared in Examples 13-14 have D50 of 351-366 mm and D100 of 1547-1592 mm, the prepared particles both reach the submicron level and have good particle size distribution, and the yields of fine powder particles are both relatively high.

In Examples 13 and 14, regarding the conditions of the presintering treatment during the post-treatment process, when the presintering temperature is too high, for example, the presintering temperature in Example 11 was 800° C., it will cause the agglomeration of particles during sintering and an increase in the particle size, thereby reducing the yield of submicron-sized particles; if the presintering temperature is too low, for example, the presintering temperature in Example 12 was 400° C., impurities can not be completely removed, which will lead to difficulties in subsequent treatment and affect the purity and properties of the product.

Therefore, accurate control of the presintering temperature is important. It is required to ensure complete removal of impurities and prevent agglomeration of particles during sintering. Only at a suitable temperature, can organic solvents, hydrogen and other impurities in the material be effectively removed. In the meanwhile, physical and chemical reactions are fully performed, helping to form submicron-sized small particles which are uniform in the particle size.

In addition, the control of presintering time is also very important for the yield of submicron-sized particles. If the presintering time is too short, it may not ensure sufficient reaction of the material and effective removal of impurities, resulting in low yield. If the presintering time is too long, it may lead to excessive sintering of the particles, which is also not conducive to ensuring a high yield of submicron-sized small particles. Therefore, it is required to shorten the presintering time as much as possible to prevent excessive sintering of particles while ensuring full reaction of the material and complete removal of impurities.

In summary, by carefully selecting and controlling the presintering temperature and time, the physical and chemical changes of the material during the presintering process can be ensured to reach the best state, and the yield of submicron-sized small particles can be improved.

As for Comparative Example 7 where the steps of greasing and dehydrogenating treatments were omitted, during the production process, impurities and hydrogen may remain in the material. Without the degreasing and dehydrogenating treatments, these impurities will remain in the material and may have adverse effects on the properties and stability of the product. The presence of impurities and hydrogen may cause changes in the physical properties of the material, such as particle shape, particle size, and the like, thus affecting the particle size distribution.

In addition, it may also cause changes in the particle shape, density, surface tension, and the like of the material. These factors will affect the dispersion and aggregation behaviors of the particles during the production process, further affecting the particle size distribution. This results in that the value of D100 reaches 1.21*10⁴ mm and the value of D50 reaches 1014 mm in Comparative Example 7.

In Comparative Examples 8-9, vacuum distillation and chemical vapor deposition were used for treatment. Compared with Example 1 where the two-fluid atomization treatment was used, comparative Examples 8-9 basically do not show significant changes in D50 but show varying changes in D100. Possible reasons are analyzed as follows:
1) During the vacuum distillation process, the particle size and particle size distribution of the titanium or titanium alloy powder are mainly controlled by the vapor condensation and evaporation rate. Since metal vapor may aggregate and condense during the condensation process, the resulting powder has a large particle size. In addition, the powder prepared by vacuum distillation is usually spherical or nearly spherical, with a relatively narrow particle size distribution, but the yield of near-micron-sized particles may be low. This is mainly because the powder prepared by vacuum distillation is usually dominated by large particles. However, submicron-sized particles easily escape or are adsorbed by large particles during the condensation process of vapor, resulting in a low yield.
2) In the chemical vapor deposition process, a gaseous precursor may collide, adsorb, and react during the deposition process, resulting in a wide particle size distribution of the formed powder. In addition, since metal powder prepared by chemical vapor deposition is usually non-spherical or irregular in shape, the fluidity of the powder is poor, which is not conducive to the collection of submicron-sized particles.

Compared with the two-fluid atomization method, the vacuum distillation method and the chemical vapor deposition method do not control the particle size and particle size distribution accurately enough in preparation of the metal powder, resulting in a lower yield of near-micron-sized particles. This may be because the control of reaction conditions and parameters during the preparation process by these two methods is not accurate or flexible enough, making it difficult to prepare spherical titanium or titanium metal powder particles with small particle sizes and uniform particle size distribution.

In Comparative Example 10-11, three-flow atomization and four-flow atomization were used for granulation, and the final particle size distribution of the powder was not much different from that of two-flow atomization.

The above are all modifications that those skilled in the art can make, as needed after reading this specification, to this example without creative contribution or solutions that obviously constitute technical inspiration. However, as long as they are within the scope of the claims of the present application, they all should be protected by the patent law.

What is claimed is:

1. A method for forming a spherical titanium or titanium alloy, comprising the following steps:
step S1: hydrogenating metal titanium or a titanium alloy to form a hydride;
step S2: coarsely grinding the hydride to form polygonal particles with a particle size of less than 10 μm;
step S3: finely grinding the polygonal particles obtained in step S2 until reaching a value of D50 of between 300 nm and 500 nm and a value of D100 of between 1200 nm and 1500 nm to obtain a material;
step S4: adding a binder to the material obtained after finely grinding and treating the material by a two-fluid atomization method; and
step S5: performing degreasing and dehydrogenating treatments on the material after being treated by the two-fluid atomization method and presintering the material to obtain a finished product.

2. The method for forming a spherical titanium or titanium alloy according to claim 1, wherein an organic solvent having a mass 0.6-10 times that of the hydride is added in the step S2, and an organic solvent having a mass 0-10 times that of a slurry of the polygonal particles is added in the step S3.

3. The method for forming a spherical titanium or titanium alloy according to claim 2, wherein the organic solvent is a non-polar solvent; and
the non-polar solvent is any one selected from a group consisting of n-heptane or xylene or a mixture of n-heptane and xylene.

4. The method for forming a spherical titanium or titanium alloy according to claim 1, wherein, in the step S2, a ball mill is used for coarse grinding, silicon carbide or zirconia is used as an abrasive, a grinding time is within a range of 1 h to 12 h, a weight ratio of the abrasive to the hydride on a dry basis is (5-50):1, and a rotation speed is within a range of 100 rpm to 300 rpm.

5. The method for forming a spherical titanium or titanium alloy according to claim 1, wherein, in the step S3, a sand mill is used for fine grinding, zirconia is used as an abrasive, a grinding time is within a range of 0.25 h to 6 h, a weight ratio of the abrasive to the hydride on a dry basis is (1-50):1, and a rotation speed is within a range of 7000 rpm to 10000 rpm.

6. The method for forming a spherical titanium or titanium alloy according to claim 1, wherein the binder in the step S4 comprises a modified polyimide and 1-2 wt % of a surfactant; and
raw materials for preparing the modified polyimide comprises the following components: 10-20 parts of polysiloxane, 5-10 parts of benzimidazole and 80-100 parts of polyimide.

7. The method for forming a spherical titanium or titanium alloy according to claim 1, wherein a presinstering temperature in the step S5 is within a range of 500° C. to 600° C.

8. A spherical titanium or titanium alloy produced by the method for forming a spherical titanium or titanium alloy according to claim 1, wherein the spherical titanium or the titanium alloy is applicable to a three-dimensional (3D) printing powder base material or metal powder injection molding process.
